(19) United States
(12) Patent Application Publication
(10) Pub. No.: US 2026/0369489 A1
(43) Pub. Date: Nov. 19, 2026

(54) INPUT APPARATUS

(71) Applicant: ALPS ALPINE CO., LTD., Tokyo (JP)

(72) Inventor: Tomoaki TSUCHIYA, Miyagi (JP)

(21) Appl. No.: 19/723,314

(22) Filed: Jun. 29, 2026

Related U.S. Application Data
(63) Continuation of application No. PCT/JP2025/007545, filed on Mar. 3, 2025.

(30) Foreign Application Priority Data
Jan. 5, 2024 (JP) 2024-000829

(51) Int. Cl. H01H 13/14; H01H 13/04

(52) U.S. Cl. CPC H01H 13/14; H01H 13/04

(57) ABSTRACT

An input apparatus includes a housing; a panel member covering the housing; a knob operated by an operator; and a contact configured to generate a signal when the knob is pressed by a predetermined pressing amount. The panel member includes a panel upper surface portion; and an opening portion formed in the panel upper surface portion and exposing a part of the knob. The knob includes a base portion having a virtual swing center axis supported by the housing and covered by the panel upper surface portion and swinging around the virtual swing center axis; a front wall portion provided at the base portion and extending from below the opening portion toward the opening portion; and an operation portion provided at an end portion of the front wall portion and exposed from the opening portion to receive an operation force. The operation portion includes a pressing operation surface portion.

### CROSS-REFERENCE TO RELATED APPLICATION

The present application is a continuation application of International Application No. PCT/JP 2025/007545 filed on Mar. 3, 2025, which is based on and claims priority to Japanese Patent Application No. 2024-000829 filed on Jan. 5, 2024. The contents of these applications are incorporated herein by reference in their entirety.

### BACKGROUND OF THE INVENTION

### 1. Field of the Invention

The present invention relates to an input apparatus.

### 2. Description of the Related Art

The following Patent Documents 1 and 2 disclose an in-vehicle switch device including a switch, a swinging knob, and a panel member, wherein the switch is pressed when the knob is swung by an operation force from a user, and a signal generated thereby drives an electric mechanism.

Patent Document 1: Japanese Unexamined Patent Application Publication No. H10-169309

Patent Document 2: Japanese Unexamined Patent Application Publication No. 2020-202084

### SUMMARY OF THE INVENTION

An input apparatus according to an embodiment includes a housing; a panel member that covers the housing; a knob operated by an operator; and a contact configured to generate a signal when the knob is pressed by a predetermined pressing amount or more, wherein the panel member includes a panel upper surface portion having a planar shape; and an opening portion formed in the panel upper surface portion and exposing at least a part of the knob, the knob includes a base portion having a virtual swing center axis supported by the housing and covered by the panel upper surface portion and swinging around the virtual swing center axis; a front wall portion provided at the base portion and extending from below the opening portion toward the opening portion; and an operation portion provided at an end portion of the front wall portion and exposed from the opening portion to receive an operation force from the operator, and the operation portion includes a pressing operation surface portion pressed by the operator, wherein when viewed from a direction of the virtual swing center axis, a vertical relative position of the pressing operation surface portion with respect to the panel upper surface portion is located above the panel upper surface portion in a neutral state released from the operation force, and when the pressing operation surface portion pressed by the operation force transitions from the neutral state to be on a same plane as the panel upper surface portion, an amount of pressing of the contact by the knob becomes less than the predetermined pressing amount and the contact is provided at a position where the signal is not generated, and when the pressing operation surface portion further pressed by the operation force transitions below the panel upper surface portion, the amount of pressing of the contact by the knob becomes greater than or equal to the predetermined pressing amount and the contact is provided at a position where the signal is generated.

### BRIEF DESCRIPTION OF DRAWINGS

FIG. 1 is a sectional view of a knob provided in the input apparatus according to an embodiment cut along the cutting line illustrated in FIG. 10;

FIG. 2 is an external perspective view of the input apparatus according to an embodiment;

FIG. 3 is a plan view of the input apparatus according to an embodiment;

FIG. 4 is a left side view of an input apparatus according to an embodiment;

FIG. 5 is a cross-sectional view of an input apparatus according to an embodiment taken along the A-A cross section line illustrated in FIG. 2;

FIG. 6 is an exploded perspective view of an input apparatus according to an embodiment;

FIG. 7 is a cross-sectional view of an input apparatus according to an embodiment taken along the B-B cross section line illustrated in FIG. 2;

FIG. 8 is an external perspective view of a knob provided in an input apparatus according to an embodiment as viewed from an oblique upper side;

FIG. 9 is an external perspective view of a knob provided in an input apparatus according to an embodiment as viewed from an oblique lower side;

FIG. 10 is a top view of a knob provided in an input apparatus according to an embodiment;

FIG. 11 is a bottom view of a knob provided in an input apparatus according to an embodiment;

FIG. 12 is a top view of a housing provided in an input apparatus according to an embodiment;

FIG. 13 is a side view of a housing provided in an input apparatus according to an embodiment;

FIG. 14 is a bottom view of a housing provided in an input apparatus according to an embodiment;

FIG. 15 is a cross-sectional view illustrating a position of a shaft portion according to an embodiment;

FIG. 16 is a transmission view illustrating an example of preferred dimensions in an input apparatus according to an embodiment;

FIG. 17 is an upper perspective view of modified example 1 of a knob provided in an input apparatus according to an embodiment;

FIG. 18 is a top view of modified example 1 of a knob provided in an input apparatus according to an embodiment;

FIG. 19 is a bottom view of modified example 1 of a knob provided in an input apparatus according to an embodiment;

FIG. 20 is a cross-sectional view illustrating a second rib provided in modified example 1 of a knob according to an embodiment;

FIG. 21 is a cross-sectional view illustrating a through-hole provided in modified example 2 of a knob according to an embodiment;

FIG. 22 is a cross-sectional view illustrating a through-hole provided in modified example 3 of a knob according to an embodiment;

FIG. 23 is an external perspective view of an input apparatus provided with modified example 4 of a knob according to an embodiment; and

FIG. 24 is a perspective view of modified example 4 of a knob according to an embodiment.

### DETAILED DESCRIPTION OF THE PREFERRED EMBODIMENTS

In the in-vehicle switch device disclosed in Patent Document 1, the entire upper surface of the knob is exposed to the operation surface. Further, in the in-vehicle switch device disclosed in Patent Document 2, the operation portion of the knob protrudes above the panel member. Therefore, when an unintended force is applied to the operation surface due to, for example, a child's mischief, the knob swings and the switch generates a signal, and, therefore, the electric mechanism is driven and the occupant of the vehicle may be exposed to danger.

Hereinafter, an embodiment will be described with reference to the accompanying drawings. In the following description, for the sake of convenience, the X-axis direction (the direction perpendicular to the center axis of the virtual swing of the knob 130) in the drawings is assumed to be the front-rear direction, the Y-axis direction (the direction parallel to the center axis of the virtual swing of the knob 130) in the drawings is assumed to be the lateral direction, and the Z-axis direction (the direction perpendicular to the center axis of the virtual swing of the knob 130) in the drawings is assumed to be the vertical direction. However, the positive direction of the X-axis is assumed to be the front direction, the positive direction of the Y-axis is assumed to be the right direction, and the positive direction of the Z-axis is assumed to be the upward direction. These are indicative of the relative positional relationship within the apparatus, and do not limit the installation direction or the operation direction of the apparatus. All elements in the apparatus having the same relative positional relationship, even if the installation direction or the operation direction is different, are included within the scope of the present invention.

### Configuration of Input Apparatus 100

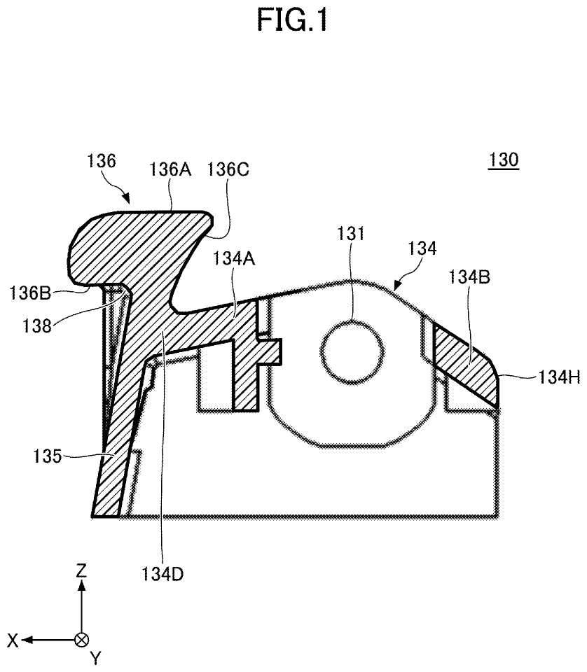

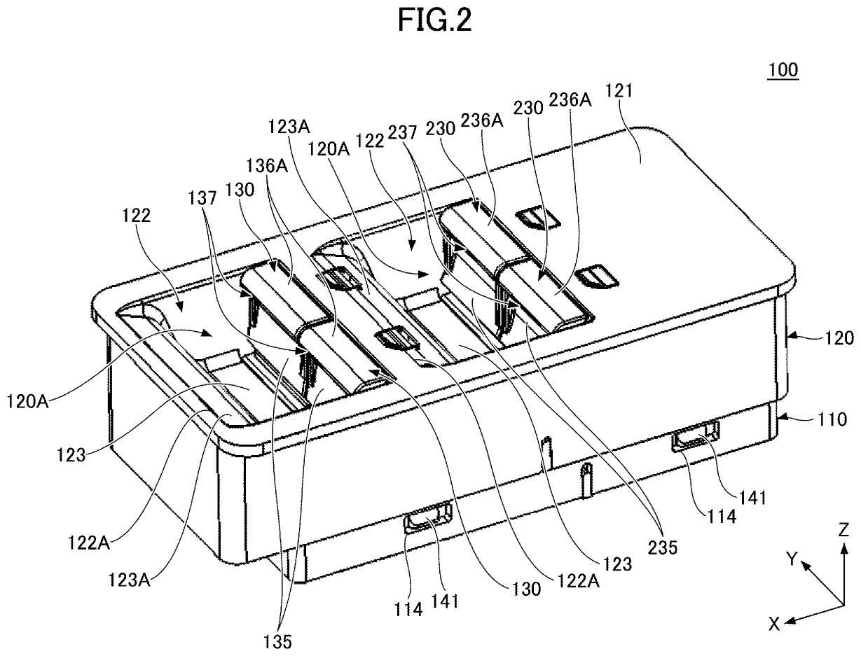

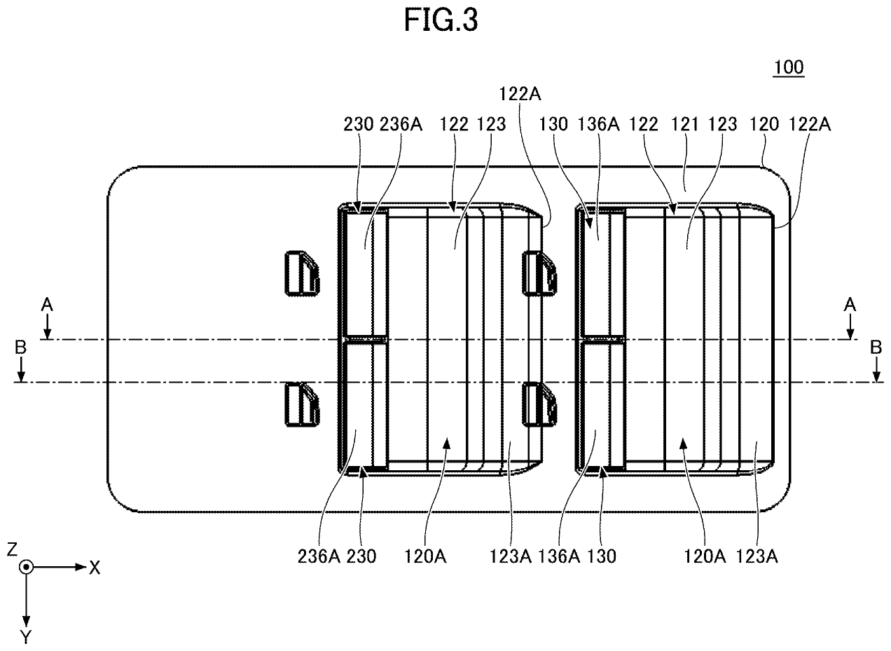

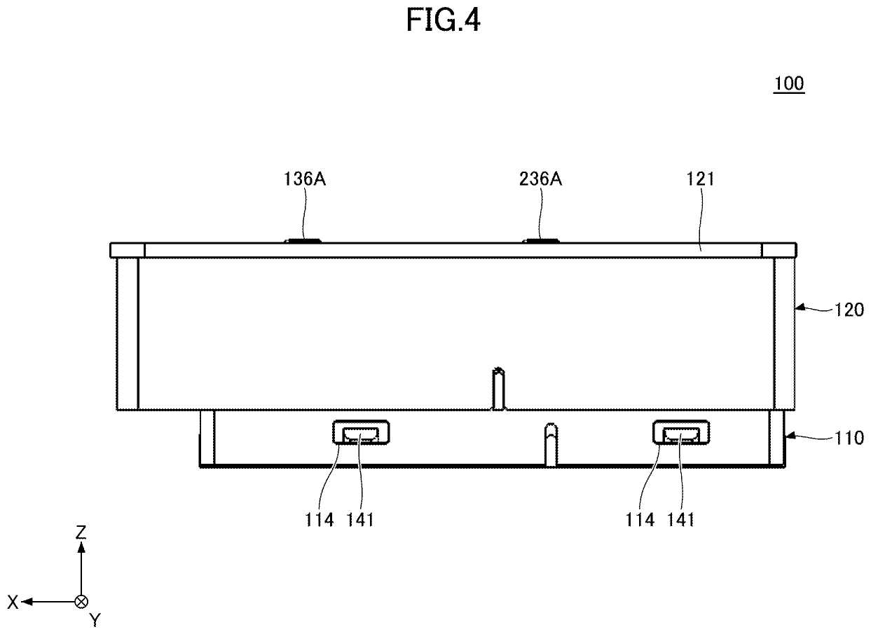

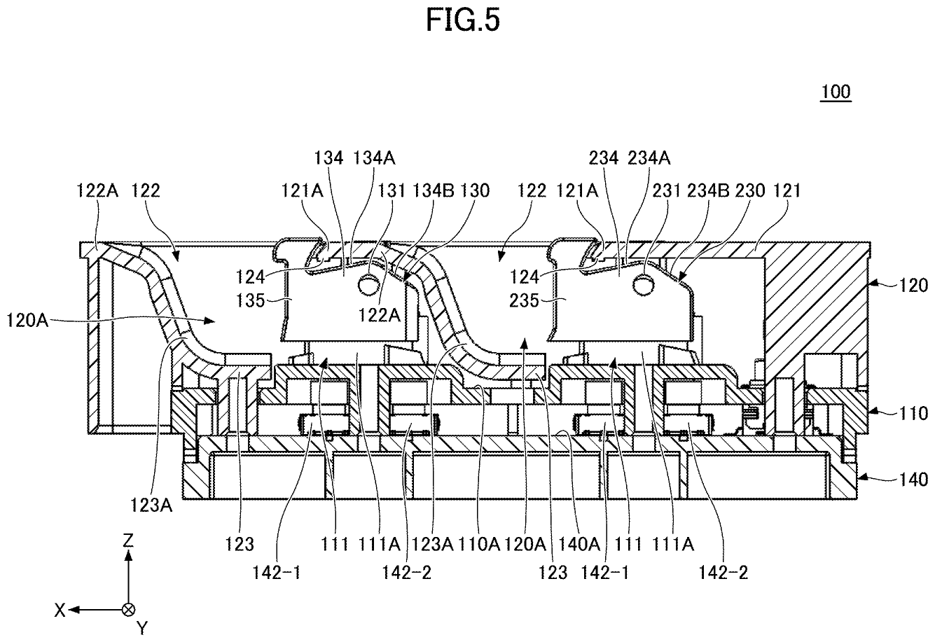

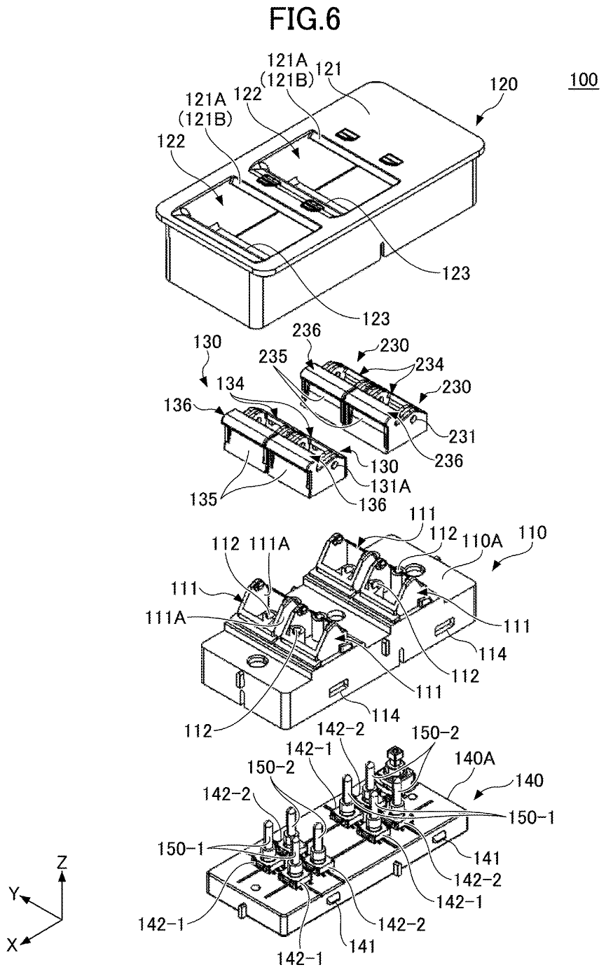

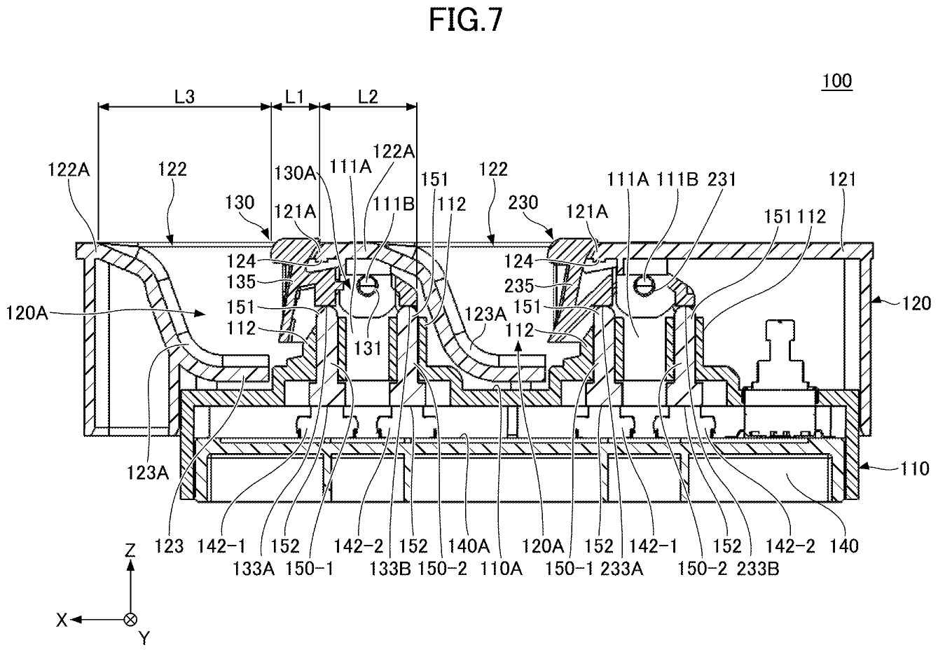

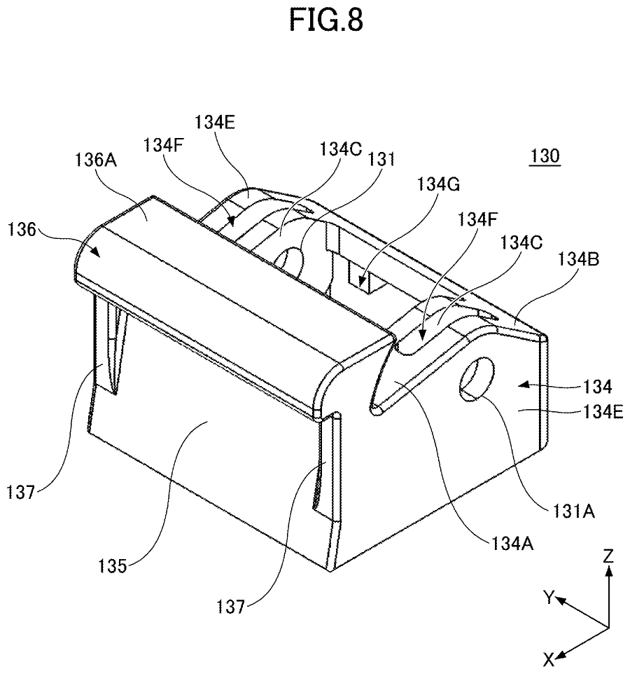

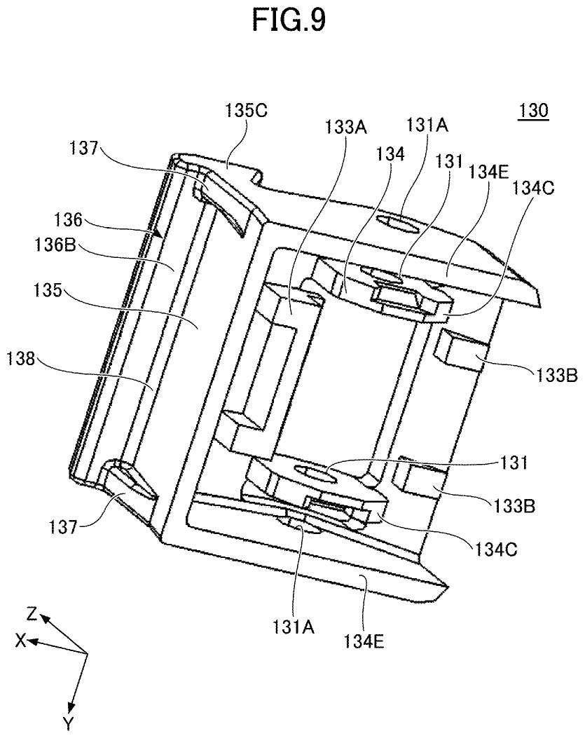

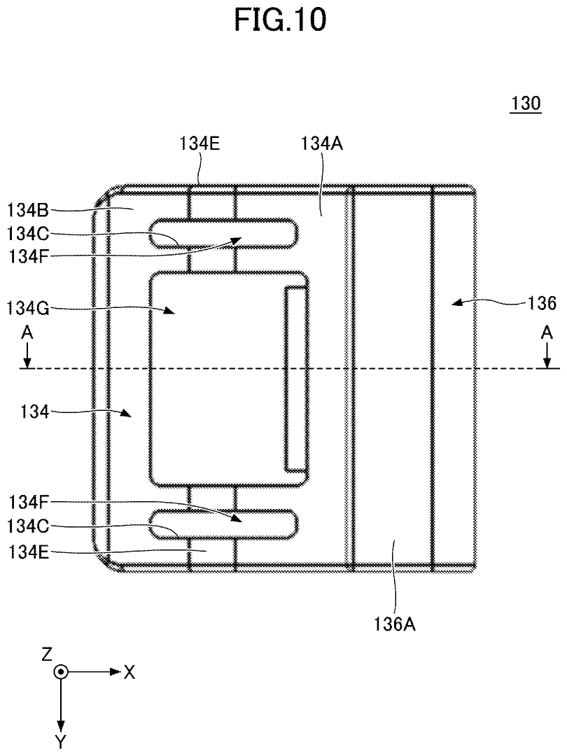

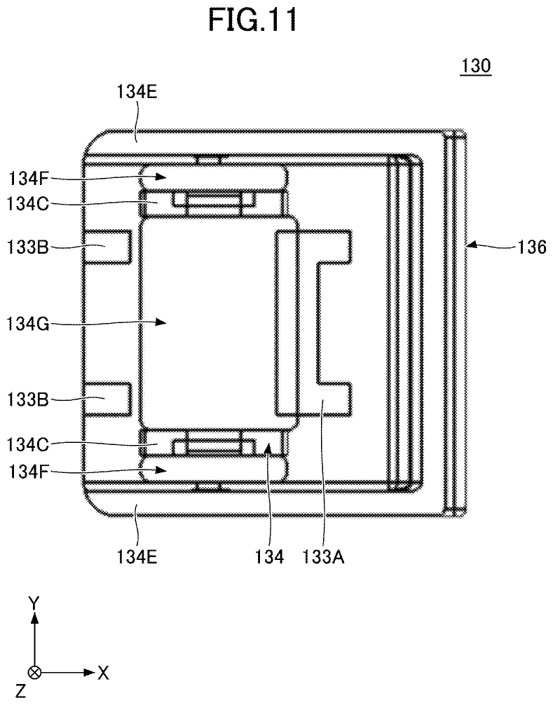

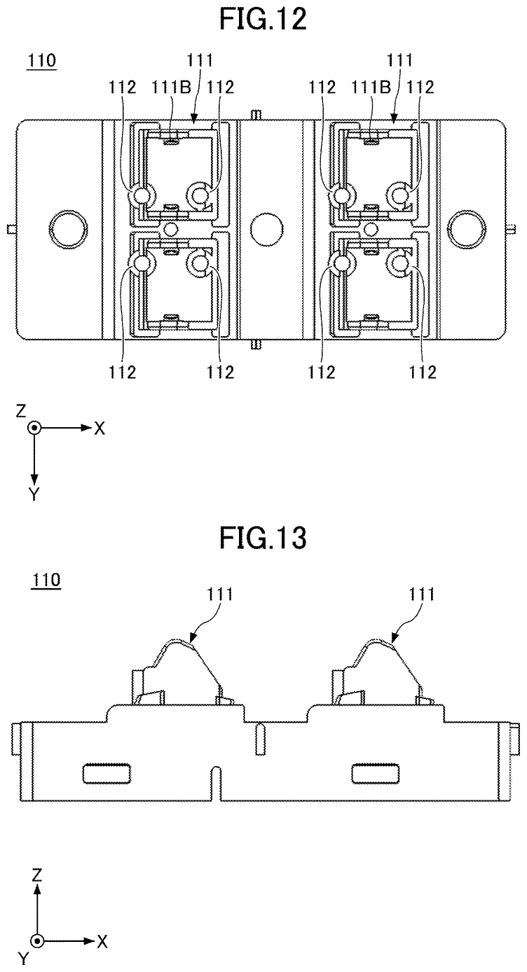

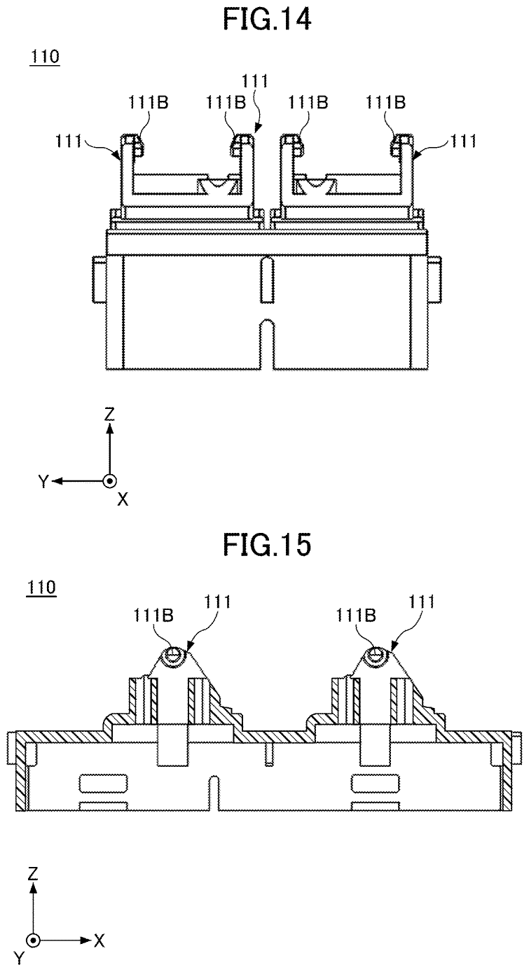

FIG. 1 is a sectional view of a knob 130 provided in an input apparatus 100 according to one embodiment, cut along the cutting line A-A illustrated in FIG. 10. FIG. 2 is an external perspective view of the input apparatus 100 according to an embodiment. FIG. 3 is a plan view of the input apparatus 100 according to an embodiment. FIG. 4 is a left side view of the input apparatus 100 according to an embodiment. FIG. 5 is a cross-sectional view of the input apparatus 100 according to an embodiment taken along the A-A cross-sectional line illustrated in FIG. 2. FIG. 6 is an exploded perspective view of the input apparatus 100 according to an embodiment. FIG. 7 is a cross-sectional view of the input apparatus 100 according to an embodiment taken along the B-B cross-sectional line illustrated in FIG. 2. FIG. 8 is an external perspective view of the knob 130 provided in the input apparatus 100 according to an embodiment as viewed from an obliquely upper side. FIG. 9 is an external perspective view of the knob 130 provided in the input apparatus 100 according to an embodiment as viewed from an obliquely lower side. FIG. 10 is a top view of the knob 130 provided in the input apparatus 100 according to an embodiment. FIG. 11 is a bottom view of the knob 130 provided in the input apparatus 100 according to an embodiment. FIG. 12 is a top view of a housing 110 provided in the input apparatus 100 according to an embodiment. FIG. 13 is a side view of a housing 110 provided in the input apparatus 100 according to an embodiment. FIG. 14 is a bottom view of a housing 110 provided in the input apparatus 100 according to an embodiment. FIG. 15 is a cross-sectional view for explaining the position of a shaft portion 111B according to an embodiment.

The input apparatus 100 illustrated in FIGS. 2 to 7 can be used as an input apparatus for operating an electrically driven in-vehicle device (e.g., electric power windows) installed in a vehicle such as an automobile.

As illustrated in FIGS. 2 and 3, the input apparatus 100 includes two knobs 130 arranged side by side in the lateral direction (Y-axis direction) on the front side (X-axis positive side), and two knobs 230 arranged side by side in the lateral direction (Y-axis direction) on the rear side (negative X-axis side). The input apparatus 100 can drive four operation objects (e.g., electric power windows) by performing a pressing operation or a pulling operation on the two knobs 130 and the two knobs 230.

As illustrated in FIGS. 2 to 7, the input apparatus 100 includes the housing 110, a panel member 120, the two knobs 130, the two knobs 230, a cover 140, and eight actuators 150.

The housing 110 is a box-shaped member made of resin and having a hollow structure with an open lower portion. In this embodiment, the housing 110 has a substantially rectangular parallelepiped shape. For example, the housing 110 is molded by an injection molding method. The cover 140 is housed inside the housing 110. In the upper portion of the housing 110, four support portions 111 are provided for supporting the two knobs 130 and the two knobs 230 in a swingable manner. Each of the four support portions 111 has a plate shape and, when viewed from the lateral direction (in the Y axis direction), has a chevron shape projecting upward (in the positive direction of the Z axis) from the upper surface 110A of the housing 110.

Each of the four support portions 111 is provided at a position corresponding to a respective one of the two knobs 130 and the two knobs 230. That is, two of the four support portions 111 are arranged in a lateral direction (Y-axis direction) on the front side (X-axis positive side) of the upper surface 110A of the housing 110. The other two of the four support portions 111 are arranged in a lateral direction (Y-axis direction) on the rear side (negative X-axis side) of the upper surface 110A of the housing 110.

Each of the support portions 111 has a substantially rectangular cylindrical shape extending in the vertical direction (Z-axis direction). Each of the support portions 111 has a pair of left and right vertical wall-like outer wall portions 111A constituting the above-described rectangular cylindrical shape. Each of the support portions 111 has a pair of shaft portions 111B provided so as to project inward from respective ones of the pair of left and right outer wall portions 111A. The shaft portion 111B has a cylindrical shape and is fitted into a bearing hole 131 formed in the knob 130 to support the knob 130 in a swingable manner. The bearing hole 131 is formed in a plate-shaped rib 134C provided in the base portion 134 of the knob 130. The bearing hole 131 is an example of a “virtual swing center axis”. The shaft portion 111B and the bearing hole 131 are provided in parallel with the lateral direction (Y-axis direction). The base portion 134 of the knob 130 has a side wall portion 134E arranged opposite to the support portion 111 of the housing 110 and provided on the side opposite to the rib 134C with respect to the support portion 111. The side wall portion 134E is a protective wall for protecting the shaft portion 111B and the bearing hole 131 from an external force, and is a structural wall for reinforcing the physical strength of the base portion 134 by being provided on the entire side portion of the base portion 134. A through-hole 131A is formed in the side wall portion 134E at a position corresponding to the bearing hole 131 in the Y-axis direction. The through-hole 131A is a peephole for facilitating visual inspection of the fitting state of the shaft portion 111B and the bearing hole 131 in the assembling process. The through-hole 131A is preferably provided coaxially with the bearing hole 131. A through-hole 134F passing through the base portion 134 in the vertical direction (Z-axis direction) is formed in the upper portion of the base portion 134. The through-hole 134F is a through-hole passing through the rib 134C and the side wall portion 134E in the Z-axis direction. By providing the through-hole 134F, the rib 134C is easily elastically deformed, so that the assembly is facilitated. Further, when the through-hole 134F is provided, for example, when it is desired to disassemble the housing 110 and the knob 130 after discovering some failure after the assembly, a disassembling tool is easily inserted between the support portion 111 and the rib 134C. A through-hole 134G passing through the base portion 134 in the vertical direction (Z-axis direction) is provided in the upper portion of the base portion 134. The through-hole 134G is a light guide hole provided on the cover 140 for guiding light from a light source (not illustrated) arranged below the through-hole 134G.

Because the support portion 111 and the rib 134C have a plate shape, after assembly, for example, when a strong force is applied to the knob 130 and a high load is applied to the shaft portion 111B and the bearing hole 131, the support portion 111 and the rib 134C are elastically deformed to follow each other and maintain a fitted state. This makes it difficult to disassemble the housing 110 and the knob 130.

As illustrated in FIGS. 13 to 15, the support portion 111 of the housing 110 of this embodiment has a chevron shape with a vertex when viewed from the Y-axis direction. The shaft portion 111B is provided at the top of the chevron shape.

As illustrated in FIG. 1, the bearing hole 131 is provided at an upper portion (a portion in the positive direction of the Z-axis) of the base portion 134, and is adjusted so that the distance between the bearing hole 131 and a panel upper surface portion 121 is reduced to the allowable strength limit of the base portion 134 and the bearing hole 131.

As a result, as illustrated in FIG. 7, between the shaft portion 111B of the housing 110 and the panel upper surface portion 121, the distance between the through-hole 131A and the panel upper surface portion 121 after assembly is reduced to a limit value that does not buffer the base portion 134 and the panel upper surface portion 121. That is, the virtual swing center axis (through-hole 131A) provided at the base portion 134 of the knob 130 is arranged at the highest position in the vertical direction (Z-axis direction) in the space below the panel upper surface portion 121. That is, although the knob 130 is arranged immediately adjacent to the panel upper surface portion 121, the swing knob 130 does not interfere with the panel upper surface portion 121 because a first inclined portion 134A and a second inclined portion 134B, which will be described below in detail, are formed at the upper end portion of the base portion 134 of the knob 130. This makes it easy to increase the distance in the vertical direction (Z-axis direction) from the position where the knob 130 contacts the actuator 150 that shifts in the vertical direction to the push switch 142, without increasing the distance from the panel upper surface portion 121 to before the upper surface 140A. Therefore, even when the distance between the bearing hole 131 and the second pressing portion 133B in the X-axis direction is made close, the direction of the moment generated when the operating force is transmitted from the second pressing portion 133B to the tip portion 151 of the actuator 150-2 can be made close to the vertical direction (Z-axis direction). Thus, because the operating force is efficiently transmitted from the knob 130 to the actuator 150-2, it becomes easy to design the operation feel and the operation load. This also makes it possible to reduce the possibility that the force lost when the operating force is transmitted may damage the knob 130. Further, because it becomes easy to set the distance between the bearing hole 131 and the second pressing portion 133B in the X-axis direction to be small while maintaining a state in which no discomfort of the operating load due to the loss of force occurs, it becomes easy to miniaturize the input apparatus 100 in the X-axis direction. Further, because it becomes easy to adjust the arrangement of the second pressing portion 133B in the front-rear direction (X-axis direction) while maintaining a state in which no discomfort of the operating load due to the loss of force occurs, it becomes easy to increase the degree of freedom in designing the operating load when the pulling operation is performed. Therefore, for example, by a technique in which the operating load when the pushing operation is performed and the operating load when the pulling operation is performed are set at the same level, it becomes easy to design in consideration of balance from the viewpoint of the operating feel. Further, by providing the first inclined portion 134A and the second inclined portion 134B, when it becomes difficult for the knob 130 and the panel upper surface portion 121 to buffer each other, it becomes easy to align the angle of contact between the second pressing portion 133B and the tip portion 151 of the actuator 150-1 and the angle of contact between the first pressing portion 133A and the tip portion 151 of the actuator 150-2. Thus, it becomes easy to adjust the operating load when the operation portion 136 is pressed and the operating load when the operation portion 136 is pulled. For example, it becomes easy to align the operating force required when the pressing operation is performed and the force required when the pulling operation is performed to the same magnitude.

The housing 110 has a pair of guide portions 112 arranged in front of and behind each of the two knobs 130 and the two knobs 230. That is, the housing 110 has a total of 8 guide portions 112. Each of the guide portions 112 has a cylindrical shape extending in the vertical direction.

The panel member 120 is a resin box-shaped member having a hollow structure. The housing 110 and the base portion 134 of the knob 130 are arranged inside the hollow structure. In this embodiment, the panel member 120 has a substantially rectangular parallelepiped shape. A housing 110, two knobs 130, and two knobs 230 are housed inside the panel member 120. That is, the panel member 120 is provided above the housing 110 and covers the housing 110. The panel member 120 is a member constituting, for example, a console of a driver's seat of a vehicle. In this embodiment, the panel member 120 and the housing 110 are in direct contact with each other and fixed by a snap-in connection, but the panel member 120 and the housing 110 may be indirectly fixed via other members.

The panel member 120 has a panel upper surface portion 121 having a planar shape parallel to the XY plane. The panel upper surface portion 121 of the panel member 120 is formed with a rectangular opening portion 122 whose longitudinal direction is the lateral direction (Y-axis direction) in a plan view from above (Z-axis positive direction). In particular, the panel upper surface portion 121 is formed with two opening portions 122 arranged in series in the front-rear direction. The opening portion 122 is a hole through which an operator inserts a finger when pulling the operation portion 136 of the knob 130. The operation portion 136 of the knob 130 is arranged so as to be exposed at the rear of the opening portion 122, and receives an operating force from an operator.

The panel member 120 has, for each of the two opening portions 122, a portion (front end portion 122A) of a panel upper surface portion 121 constituting the front (X-axis positive direction) side of the opening portion 122, a bottom wall portion 123 provided below the opening portion 122 substantially parallel to the XY plane, and a connecting portion 123A extending downward from the front end portion 122A and connecting the front end portion 122A and the bottom wall portion 123. As illustrated in FIGS. 5 and 7, the bottom wall portion 123 and the connecting portion 123A have a curved shape, and cover the front side (X-axis positive side) and the lower side (Z-axis negative side) of a space 120A below the opening portion 122 in the panel member 120.

Each of the two knobs 130 and the two knobs 230 is a resin-made member which swings by receiving an operating force from an operator. Each of the two knobs 130 and the two knobs 230 has a substantially rectangular parallelepiped shape and a hollow structure. In the assembling process, the support portion 111 of the housing 110 is inserted into the hollow structure from the lower side. Each of the two knobs 130 and the two knobs 230 is arranged above the housing 110 and is connected to a corresponding support portion 111 of the housing 110 so as to be swingably supported with respect to the housing 110. Each of the knobs 130 has a bearing hole 131 on both right and left side surfaces. Each knob 130 is rotatably supported with respect to the housing 110 by using the pair of left and right shaft portions 111B as a virtual swing center axis by fitting each of the pair of left and right bearing holes 131 into each of the pair of left and right shaft portions 111B provided in the support portion 111. The range of the rotation stroke of each knob 130 is defined by the mechanical stopper 124 described below in detail and the lower end of the stroke of the push switch 142-1. When the knob 130 rotates, the operation portion 136 swings upward (in the positive direction of the Z-axis) and downward (in the negative direction of the Z-axis). Each knob 130 has two ribs 134C (see FIGS. 8 and 9) parallel to the XZ plane. The two ribs 134C are arranged on the left side and the right side of the hollow structure, respectively. The bearing hole 131 is formed to penetrate the ribs 134C in the Y-axis direction. Each knob 130 has a front wall portion 135 formed continuously with an end portion 134D (an example of “one end”) on the front side of the base portion 134. As illustrated in FIG. 2, the front wall portion 135 closes the side of the knob 130 in the positive direction of the X-axis. In this embodiment, the front wall portion 135 has a plate shape substantially parallel to the YZ plane, but the front wall portion 135 need not necessarily have a planar shape. The front wall portion 135 may have, for example, a curved shape in part, an undulating shape, or a wavy shape in part. As illustrated in FIGS. 1 and 7, the front wall portion 135 extends from an end portion 134D on the front side (in the positive direction of the X-axis) of the base portion 134 toward the rear side of the opening portion 122. The upper end portion of the front wall portion 135 includes an operation portion 136 that extends in parallel with the XY plane and accepts an operation by an operator. Note that the operation portion 136 preferably extends in a direction that intersects the front wall portion 135 and in a direction that is parallel to the virtual swing center axis, and the operation portion 136 need not extend parallel to the XY plane. When the operation portion 136 is extended parallel to the XY plane, the operation portion 136 is easily visible from above even when the dimension is set to be small. The operation portion 136 is arranged along the rear end portion of the opening portion 122 in a neutral state. That is, the front wall portion 135 extends substantially upward from the end portion 134D of the knob 130. As illustrated in FIGS. 5 to 7, the panel member 120 has a facing portion 121A (an example of a “first facing surface portion”) provided on negative X-axis sidethe negative X-axis side of the inner wall 121B constituting the opening portion 122 so as to face the operation portion 136 of the knob 130 and formed so as to obliquely intersect the panel upper surface portion 121. An operation portion 136 parallel to the panel upper surface portion 121 is formed on the upper end portion of the front wall portion 135 of the knob 130, and the operation portion 136 is arranged on the rear side of the opening portion 122. That is, the operation portion 136 is arranged so as to face the facing portion 121A of the panel upper surface portion 121 constituting the rear side of the opening portion 122 and is arranged in front of the facing portion 121A (in the X-axis positive direction). The operation portion 136 has a facing portion 136C (an example of a “second facing surface portion”) arranged so as to face the facing portion 121A on negative X-axis sidethe negative X-axis side. In order to suppress the intrusion of foreign matter, the distance between the facing portion 121A and the facing portion 136C in the neutral state is preferably set to be as small as possible while ensuring that these portions do not interfere with each other. The facing portion 121A of the panel member 120 and the facing portion 136C of the knob 130 have a plane shape or a curved shape parallel to each other with a minute gap. The angle between the facing portion 121A of the panel member 120 and the facing portion 136C of the knob 130 is not required to be completely parallel, and may deviate as long as it is within a range ensuring that there is no interference with the operation of the knob 130. From the viewpoint of reducing the distance between the facing portion 121A and the facing portion 136C, it is preferable that the facing portion 121A of the panel member 120 and the facing portion 136C of the knob 130 have the same curvature as the side surface of the cylinder about the virtual swing center axis of the knob 130 and have a curved shape overlapping with the side surface of the cylinder. As illustrated in FIG. 7, it is preferable that the facing portion 121A of the panel member 120 and the facing portion 136C of the knob 130 are formed obliquely with respect to the plane direction (XY plane direction) formed by the panel upper surface portion 121. This makes it possible to reduce the possibility that dust or water enters the apparatus through the through-hole 134G. Moreover, it is possible to reduce the possibility that a problem occurs in which the rotation of the knob 130 is stuck due to a foreign substance being caught between the knob 130 and the panel upper surface portion 121. Further, the front wall portion 135 extends substantially downward from the end portion 134D of the knob 130 and closes the front side of the base portion 134. As illustrated in FIG. 1, in this embodiment, the front wall portion 135 is generally planar, but the front wall portion 135 may be partially curved.

In the internal space 130A of the knob 130, a first pressing portion 133A is provided in front of the pair of left and right bearing holes 131 (on the positive side of the X-axis). The first pressing portion 133A is a downward horizontal plane portion, contacts the tip portion 151 of the actuator 150-1, and presses the actuator 150-1 when the knob 130 swings downward (in the negative direction of the Z-axis).

In the internal space 130A of the knob 130, a second pressing portion 133B is provided to the rear of the pair of left and right bearing holes 131 (on the negative side of the X-axis). The second pressing portion 133B is a downward horizontal plane portion, contacts the tip portion 151 of the actuator 150-2, and presses the actuator 150-2 when the knob 130 swings upward (in the positive direction of the Z-axis).

The cover 140 is a rigid, resin-made, flat-plate member which is fitted into the lower opening portion 110B of the housing 110 to close the lower opening portion 110B. The cover 140 has a rectangular shape in which the front-rear direction (in the X-axis direction) is the longitudinal direction in a plan view from above. The upper surface 140A of the cover 140 functions as a substrate on which various electronic components are mounted. A plurality of engaging claws 141 are provided on the side surface of the cover 140.

The cover 140 is fixed to the housing 110 in such a posture that the upper surface 140A is parallel to the XY plane by engaging the plurality of engaging claws 141 with the plurality of opening portions 114 formed in the side surface of the housing 110. Although the cover 140 is described as a single member in this embodiment, the cover 140 may be a combination of a substrate and a resin member.

On the upper surface 140A of the cover 140, on the lower side of each of the two knobs 130 and the two knobs 230, two push switches 142-1 and 142-2 are arranged side by side in the front-rear direction (X-axis direction) with the push switch 142-1 on the front side (X-axis positive side). That is, on the upper surface 140A of the cover 140, a total of eight push switches 142 (an example of “contacts pressed by knobs”) are arranged. The push switch 142 is a switch mechanism that generates a signal when the push switch is pressed by a predetermined amount or more. Although a tact switch (registered trademark) is used as an example of the push switch 142 in this embodiment, the push switch 142 may be any electrical element that is switched when the knob 130 is rotated, and need not be a tact switch (registered trademark). The push switch 142 may be a rubber dome switch. The push switch 142 may be a double-action type tact switch (registered trademark) that incorporates two return members that can be reversed. The contact of the present invention is not limited to the contact mechanism in which the contact member and the return member are incorporated, but may be a combination of the contact member and the return member set so as to be interlocked. For example, the push switch 142 may be a signal generating mechanism configured by combining a pressure sensor and a return member. The push switch 142 may be a detection signal generating mechanism configured by combining, for example, a force converting member for replacing the rotational stroke of the knob 130 with a linear stroke parallel to the upper surface 140A, a sliding contact mechanism, and a return member. The push switch 142 may be a signal generating mechanism configured by combining, for example, an optical detecting mechanism including an infrared sensor and capable of detecting the distance between the knob 130 and the upper surface 140A of the cover 140, and a return member.

Each of the eight actuators 150 is a cylindrical member made of resin and arranged above the corresponding push switch 142. Each actuator 150 is arranged in a guide portion 112 of the housing 110 movably in the vertical direction (Z-axis direction). The actuator 150 is arranged inside the guide portion 112 so that the curved tip portion 151 faces upward.

The input apparatus 100 has an actuator 150-1 on the front side (X-axis positive side) and an actuator 150-2 on the rear side (negative X-axis side) with respect to each of the four push switches 142.

In the actuator 150-1, the tip portion 151 is in contact with the first pressing portion 133A of the knob 130, and the lower surface 152 is in contact with the upper surface of the push switch 142-1. In the actuator 150-2, the tip portion 151 is in contact with the second pressing portion 133B of the knob 130, and the lower surface 152 is in contact with the upper surface of the push switch 142-2.

### Operation of the Input Apparatus 100

In the input apparatus 100 configured as described above, when the knob 130 is not operated, the first pressing portion 133A and the second pressing portion 133B of the knob 130 are biased upward, with front-rear symmetry, by the push switch 142-1 and the push switch 142-2 via the actuator 150-1 and the actuator 150-2. Therefore, when the knob 130 is not operated, the knob 130 can maintain a neutral state.

When the operator pulls up the operation portion 136 of the knob 130, the knob 130 swings forward and the second pressing portion 133B of the knob 130 presses the push switch 142-2 via the actuator 150-2. Thus, the push switch 142-2 is switched to a switch-on state and outputs a detection signal.

When the operator presses down the operation portion 136 of the knob 130, the knob 130 swings forward and downward, and the first pressing portion 133A of the knob 130 presses the push switch 142-1 via the actuator 150-1. Thus, the push switch 142-1 is switched to the switch-on state and outputs a detection signal.

Furthermore, when the operation of the knob 130 is released, the knob 130 returns to the neutral state and maintains the neutral state by utilizing the biasing force from the push switch 142-1 or the push switch 142-2.

Here, in the input apparatus 100 according to one embodiment, the knob 130 has a virtual swing center axis supported in a swingable manner by a support portion 111 of the housing 110, and has a base portion 134 covered with a panel upper surface portion 121.

The knob 130 also has a front wall portion 135 and an operation portion 136. The front wall portion 135 has a plate shape parallel to the axial direction of the virtual swing center axis, and at least a part thereof extends from one end of the base portion 134 near the opening portion 122 toward the opening portion 122. The operation portion 136 is provided at an end of the front wall portion 135 on the side of the opening portion 122, and receives an operation force from an operator.

The operation portion 136 of the knob 130 has a pressing operation surface portion 136A, a pulling operation surface portion 136B, and a first rib 137. The pressing operation surface portion 136A has a planar shape. The pressing operation surface portion 136A is provided on the same plane as the panel upper surface portion 121 in a neutral state released from the operation force to the operation portion 136. The pulling operation surface portion 136B is formed on the back side of the pressing operation surface portion 136A of the operation portion 136, and intersects the front wall portion 135 to form a recessed part. That is, the pulling operation surface portion 136B is an internal angle formed by intersecting the operation portion 136 and the front wall portion 135 when viewed from the Y-axis direction. The pulling operation surface portion 136B forms a recessed part on the back side of the pressing operation surface portion 136A and on the side far from the virtual swing center axis (through-hole 131A). A first rib 137 is provided in the recessed part, connects the front wall portion 135 and the pulling operation surface portion 136B, and extends in a plane direction perpendicular to the axial direction of the virtual swing center axis. A pair of the first ribs 137 are provided at one side edge part and the other side edge part of the front wall portion 135 in the axial direction of the virtual swing center axis. That is, a pair of the first ribs 137 are provided on the front wall portion 135 while being spaced apart in the direction of the virtual swing center axis.

As a result, the input apparatus 100 according to one embodiment can securely hold the finger of the operator by the pulling operation surface portion 136B when the operator's finger pulls up the operation portion 136, and thus can reliably perform the operation.

In particular, in the present embodiment, the operation portion 136 has a substantially quarter circle shape when viewed from the lateral direction (Y-axis direction), and the pulling operation surface portion 136B, which is the lower surface of the operation portion 136, is a horizontal plane. As a result, the input apparatus 100 according to one embodiment can prevent the finger of the operator from slipping off the pulling operation surface portion 136B when the operator's finger pulls up the operation portion 136, and thus can more reliably perform the operation.

The pressing operation surface portion 136A of the operation portion 136 has a planar shape parallel to the XY plane and is on the same plane as the panel upper surface portion 121 of the panel member 120.

As a result, the input apparatus 100 according to one embodiment can prevent the operation portion 136 from protruding beyond the panel upper surface portion 121, and can make it difficult for an object to be caught by the operation portion 136, and thus can prevent erroneous operation of pulling up the operation portion 136.

Note that “on the same plane” is not limited to the case where the height position of the pressing operation surface portion 136A and the height position of the panel upper surface portion 121 completely coincide, but also includes the case where the height position of the pressing operation surface portion 136A is slightly higher than the height position of the panel upper surface portion 121 and the case where the height position of the pressing operation surface portion 136A is slightly lower than the height position of the panel upper surface portion 121. In this embodiment, the pressing operation surface portion 136A of the knob 130 in the neutral state is arranged at a position where the vertical relative position with respect to the panel upper surface portion 121 is 0.1 mm higher than the panel upper surface portion 121. Further, in this embodiment, when the pressing operation surface portion 136A is pressed downward to make a transition of 1.4 mm, the push switch 142-1 generates a signal when it is pressed 1.5 mm or more (an example of “a predetermined amount or more”). Therefore, for example, when the pressing operation surface portion 136A is pressed by an act such as the operator putting their elbow on the panel upper surface portion 121, and the pressing operation surface portion 136A makes a transition of 0.1 mm to the same height as the panel upper surface portion 121, the amount of the knob 130 pressed to the push switch 142-1 is smaller than 1.5 mm, which is a predetermined amount for generating a signal, and the push switch 142-1 does not generate a signal. When the height position of the pressing operation surface portion 136A is originally set at a position lower than the height position of the panel upper surface portion 121, even if the operator puts their elbow on the panel upper surface portion 121, the pressing operation surface portion 136A is not pressed and does not make a transition, and therefore the push switch 142-1 does not generate a signal. In the configuration of this embodiment, because the panel upper surface portion 121 covers the upper part of the base portion 134 of the knob 130, when the operator puts their elbow on the panel upper surface portion 121 or the like, there is no possibility that the knob 130 is erroneously rotated in the opposite direction, and therefore there is no possibility that the rear push switch 142-2 is pressed.

Further, the base portion 134 of the knob 130 has a chevron shape including a first inclined portion 134A which is provided forward (X axis positive direction) of the virtual swing center axis (that is, bearing hole 131) and inclined forward when viewed from the axial direction (i.e. in the Y-axis direction) of the virtual swing center axis of the knob 130, and a second inclined portion 134B which is provided rearward (Y axis negative direction) of the virtual swing center axis (that is, bearing hole 131) and inclined rearward. That is, when viewed from the axial direction (Y-axis direction) of the virtual swing center axis of the knob 130, the base portion 134 is provided closer to the opening portion 122 than the virtual swing center axis of the knob 130 to the side of the panel upper surface portion 121, and has a first inclined portion 134A which is inclined in such a direction that the distance from the panel upper surface portion 121 increases as the distance from the opening portion 122 decreases with respect to the panel upper surface portion 121. Further, the base portion 134 has a second inclined portion 134B which is provided on the side of the panel upper surface portion 121 opposite to the first inclined portion 134A with respect to the virtual swing center axis of the knob 130 when viewed from the axial direction (Y-axis direction) of the virtual swing center axis of the knob 130, and which is inclined in such a direction that the distance from the panel upper surface portion 121 increases as the distance from the opening portion 122 increases with respect to the panel upper surface portion 121. In this embodiment, the first inclined portion 134A has a planar shape, but the inclination of the tilt with respect to the panel upper surface portion 121 may be the same as described above, and the first inclined portion 134A may have a curved shape. The same applies to the second inclined portion 134B.

Thus, the input apparatus 100 according to an embodiment can bring the virtual swing center axis (that is, bearing hole 131) of the knob 130 closer to the panel upper surface portion 121 (that is, the height position of the virtual swing center axis of the knob 130 can be further increased), and the base portion 134 having the above-described chevron shape can prevent the base portion 134 from interfering with the panel upper surface portion 121 when the knob 130 swings.

Further, as illustrated in FIGS. 5 and 7, the panel upper surface portion 121 of the panel member 120 has a protrusion-shaped mechanical stopper 124 provided protruding toward the first inclined portion 134A on the lower surface of the panel upper surface portion 121 (the surface of the knob 130 facing the first inclined portion 134A) and on the rear side of the opening portion 122 (negative X-axis sidethe negative X-axis side). The mechanical stopper 124 faces the first inclined portion 134A of the base portion 134 of the knob 130 at a predetermined distance, and comes into contact with the front end portion (the X-axis positive end portion) of the first inclined portion 134A when the knob 130 swings upward by a predetermined amount.

Thus, the input apparatus 100 according to an embodiment can restrict the upward swing amount of the knob 130 to a predetermined amount. Further, in the input apparatus 100 according to an embodiment, by bringing the mechanical stopper 124 into contact with the front end portion (that is, the vicinity of the operation portion 136) of the first inclined portion 134A of the base portion 134, the deterrent force of the mechanical stopper 124 can be efficiently transmitted to the operator's finger, and bending of the knob 130 as a whole can be suppressed, so that breakage of the knob 130 can be suppressed.

Further, as illustrated in FIGS. 8 and 9, the knob 130 has a pair of first ribs 137 provided at the corner portion 138 formed by the front wall portion 135 and the operation portion 136 at both end portions in the axial direction (Y-axis direction) of the virtual swing center axis of the knob 130. In this embodiment, as an example, the first ribs 137 have a vertical substantially triangular plate shape, with the upper side thereof connected to the operation portion 136 and the rear side thereof connected to the front wall portion 135.

Thus, in the input apparatus 100 according to an embodiment, the strength of the operation portion 136 can be increased, and breakage of the operation portion 136 can be prevented. Further, because the input apparatus 100 according to an embodiment is provided at both end portions of the pair of first ribs 137 in the axial direction (Y-axis direction) of the virtual swing center axis of the knob 130, when the operation portion 136 is pulled up by the fingers of the operator, the fingers of the operator can be inserted between the pair of first ribs 137, and the pair of first ribs 137 can be prevented from interfering with the operation. The corner portion 138 formed by the front wall portion 135 and the operation portion 136 is an example of a “recessed portion” and is an acute angle. That is, an internal angle formed by crossing the operation portion 136 and the front wall portion 135 on the rear surface side of the operation portion 136 (the side in the negative direction of the Z-axis) and on the side far from the virtual swing center axis of the knob 130 (the side in the positive direction of the X-axis) is an acute angle. That is, as illustrated in FIG. 1, when viewed from the Y-axis direction, the shape formed by the front wall portion 135 and the operation portion 136 is similar to an Arabic numeral “7”.

### Example of Suitable Dimensions

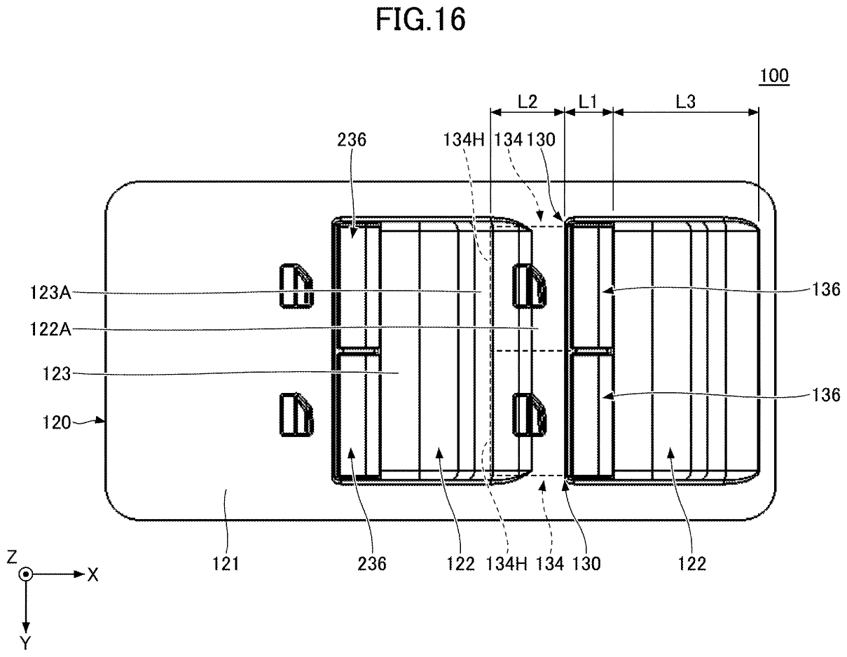

FIG. 16 is a transparent view illustrating an example of suitable dimensions of the input apparatus 100 according to an embodiment. Dotted lines drawn in FIG. 16 indicate positions of a base portion 134 arranged below the panel upper surface portion 121 and its rear end portion 134H.

As illustrated in FIG. 16, the dimension of the operation portion 136 in the front-rear direction (X-axis direction) is defined as a width L1, and the dimension obtained by subtracting the dimension of the width occupied by the operation portion 136 from the dimension of the entire knob 130 is defined as a width L2. The dimension obtained by subtracting L1 from the dimension of the opening portion 122 in the front-rear direction (X-axis direction) is defined as a width L3. Preferably, the width L1 is set to the minimum dimension required for an average adult male to press the operation portion 136 with his fingertips without discomfort. The width L3 is set to the dimension required for an adult male to insert his fingertips into the opening portion 122 when performing a pulling operation. The width L2 is set in consideration of the width L1, the width L3, the operating load when performing the pushing operation, the operating load when performing the pulling operation, and the condition that the rear end portion 134H of the base portion 134 and the front end portion 122A of the panel member 120 do not interfere with each other. In view of the general market need for a compact input apparatus, it is preferable to set the width L2 to be as small as possible.

In the present embodiment, the width L1 of the operation portion 136 in the front-rear direction (X-axis direction) is 6 mm. The width L2 obtained by subtracting the dimension of the operation portion 136 from the dimension of the entire knob 130 in the front-rear direction (X-axis direction) is 12 mm. That is, the ratio of the width L1 of the operation portion 136 to the width L2 obtained by subtracting the dimension of the operation portion 136 from the dimension of the entire knob 130 is 6:12. When the width L1 is 6 mm, the width L2 is preferably between 11 mm and 13 mm. That is, when the dimension ratio is compared, if the value of the width L1 is 1, the value of the width L2 is preferably from 1.8 to 2.2. When the width L2 is set to 10 mm or less, it is difficult to set the operating load at the time of the pressing operation and the operating load at the time of the pulling operation to the same level, and, therefore, the balance of the operating feel is degraded. When the width L2 is set to 14 mm or more, the size of the input apparatus is increased. In the input apparatus 100 of this embodiment, because the base portion 134 has the first inclined portion 134A and the second inclined portion 134B, it is easy to set the width L2 to a suitable value.

In the present embodiment, the dimension (width L3) obtained by subtracting the width L1 from the dimension (28 mm) of the opening portion 122 in the front-rear direction (X-axis direction) is 22 mm. That is, the ratio of the dimension L3 obtained by subtracting the width L1 from the dimension of the opening portion 122 to the dimension L1 of the operation portion 136 is 22:6. From the viewpoint of market needs for miniaturization, it is preferable to set the width L3 to be as small as possible while keeping a size sufficient for an adult male to insert his fingertip into the opening portion 122. On the other hand, it is preferable that the shape extending from the front end portion 122A to the connecting portion 123A has a curved surface shape having a predetermined radius of curvature so that the operator can easily find a position to be operated depending on the tactile sensation when operating the input apparatus 100 by blind touch without seeing the input apparatus. When the curved surface shape is formed from the front end portion 122A to the connecting portion 123A, the operator can easily find the operation portion 136 depending on the tactile sensation. When a curved surface shape is not formed from the front end portion 122A to the connecting portion 123A, the minimum dimension required for the width L3 is 11 mm. The width L3 is set to be large depending on the size of the radius of curvature of the curved surface provided at the connecting portion 123A. From the viewpoint of maintaining good operability, the width L3 is preferably set to be in the range of 11 mm to 22 mm. That is, when the dimension ratio is compared, if the value of the width L1 is 1, the value of the width L3 is preferably 1.8~3.7.

### Modified Example 1 of the Knob 130)

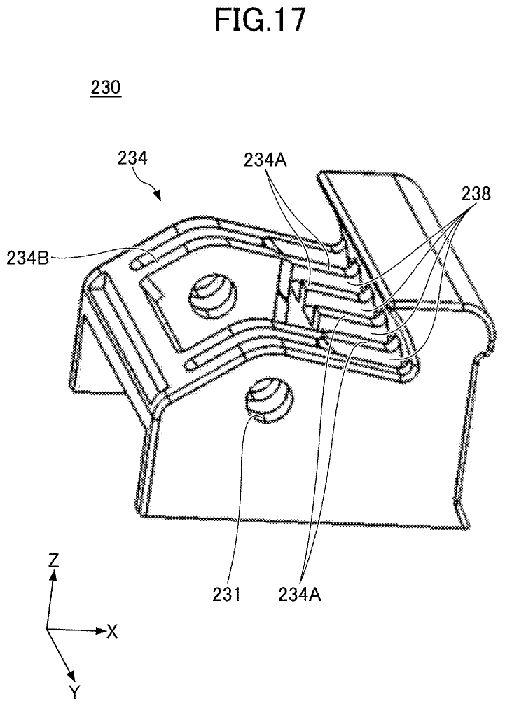

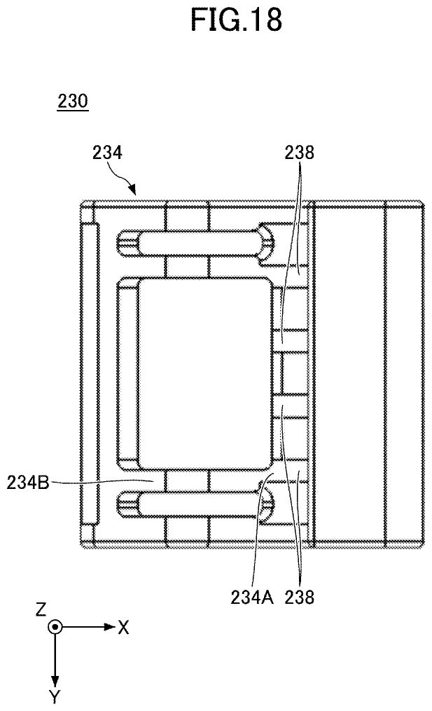

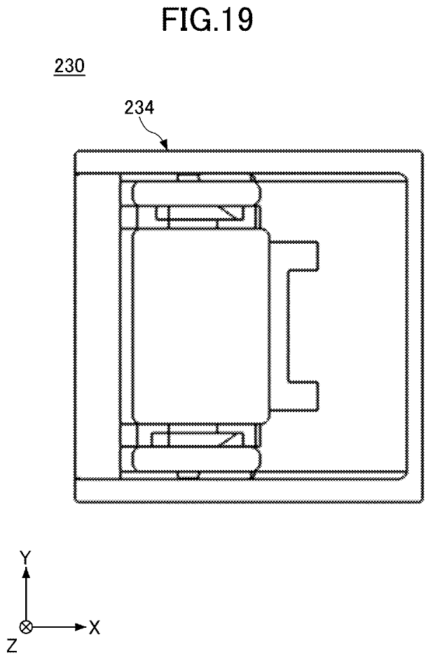

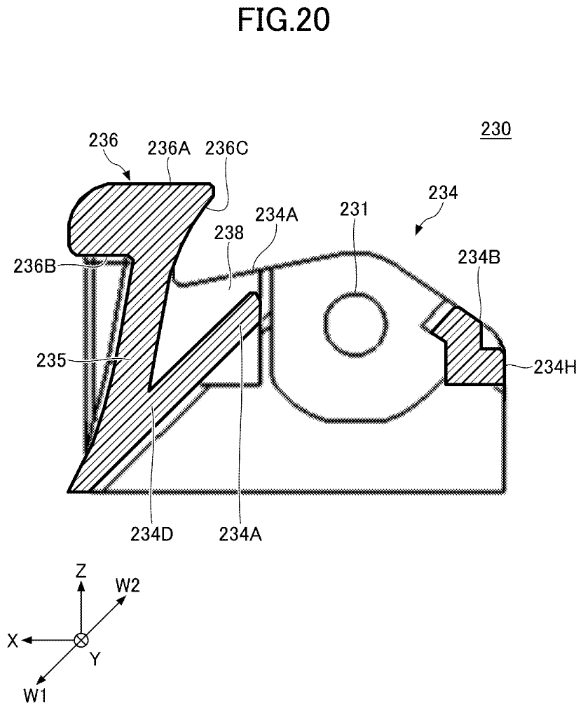

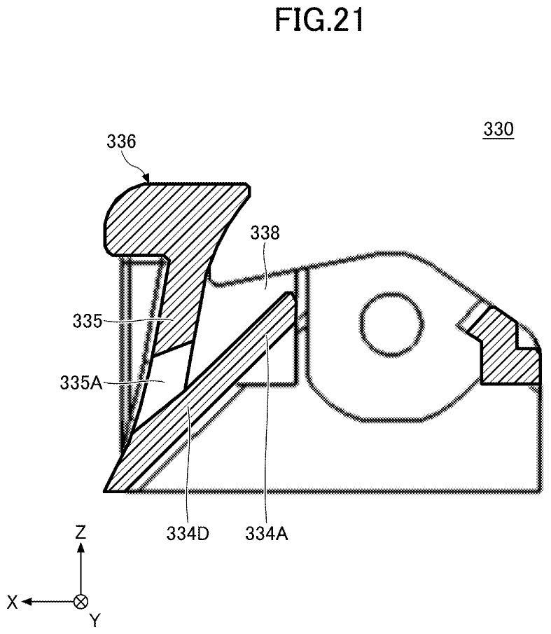

FIG. 17 is an upper perspective view of modified example 1 of the knob 130 included in an input apparatus according to an embodiment. FIG. 18 is a top view of modified example 1 of the knob 130 included in an input apparatus according to an embodiment. FIG. 19 is a bottom view of modified example 1 of the knob 130 included in an input apparatus according to an embodiment. FIG. 20 is a cross-sectional view for explaining a second rib 238 included in modified example 1 of the knob 130 according to an embodiment.

The knob 230 illustrated in FIGS. 17 to 20 is modified example 1 of the knob 130 according to an embodiment. As illustrated in FIGS. 17 to 20, the knob 230 has a second rib 238 extending parallel to the XZ plane on the side of the front wall portion 235 in the negative direction of the X axis. An end face of the second rib 238 on the upper side (on the positive side of the Z axis) is a first inclined portion 234A. When viewed from the Y-axis direction of the knob 230, the first inclined portion 234A is provided on the positive X-axis side of the virtual swing center axis (that is, bearing hole 231) of the base portion 234 of the knob 230. Further, the knob 230 has a second inclined portion 234B which is provided on the rearward side (negative X-axis side) of the virtual swing center axis (that is, bearing hole 131) of the base portion 234 and which is inclined downward. In the example illustrated in FIGS. 17 to 20, the knob 230 has four second ribs 238 arranged in the Y-axis direction. Each of the four second ribs 238 is a wall perpendicular to the axial direction (Y-axis direction) of the virtual swing center axis.

Thus, the knob 230 can reinforce the front wall portion 235 and the base portion 234, and can suppress deformation of the front wall portion 235 when the operation portion 236 receives an operation.

The knob 230 has a structure superior in productivity to other embodiments of the present application. The direction (W1 direction, W2 direction) parallel to the XZ plane illustrated in FIG. 20 is the direction in which the mold is pulled out when the knob 230 is manufactured using the resin molding method. All shapes constituting the knob 230 except the bearing hole 231 do not collide with the direction in which the mold is pulled out (W1 direction, W2 direction). In order to reduce the work force required for pulling out the mold, all shapes of the knob 230 except the bearing hole 231 are preferably set to be obliquely intersecting with the direction of pulling out the mold (W1 direction and W2 direction illustrated in FIG. 20). When viewed from the axial direction (Y-axis direction) of the virtual swing center axis, an internal angle formed by crossing the operation portion 236 and the front wall portion 235 is set to be an acute angle. When viewed from the axial direction (Y-axis direction) of the virtual swing center axis, an internal angle formed by crossing the front wall portion 235 and the first inclined portion 234A is set to be an acute angle. When viewed from the axial direction (Y-axis direction) of the virtual swing center axis, the operation portion 236, the front wall portion 235, and the first inclined portion 234A have shapes similar to the letter “Z”.

### Modified Example 2 of the Knob 130

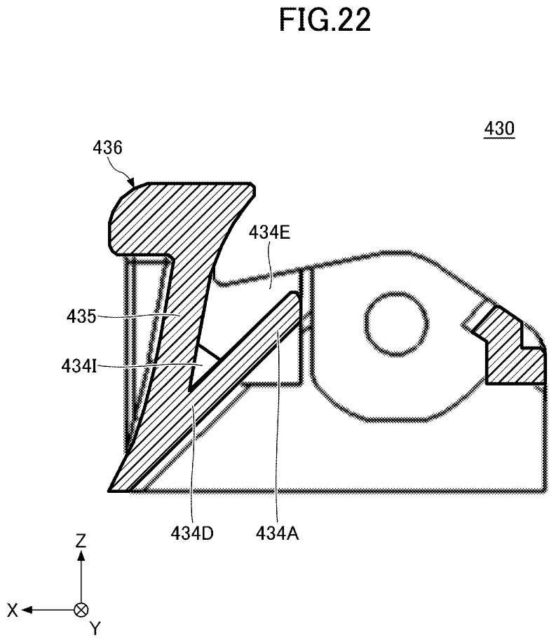

FIG. 21 is a sectional view for explaining the through-hole of modified example 2 of the knob 130 according to one embodiment. The knob 330 illustrated in FIG. 21 is modified example 2 of the knob 130 according to one embodiment. As illustrated in FIG. 21, the knob 330 has a through-hole 335A penetrating the front wall portion 335 on the side of the operation portion 336 from the end portion 334D of the front wall portion 335. Thus, the knob 330 can discharge water entering between the front wall portion 335 and the first inclined portion 334A from the through-hole 335A. That is, the front wall portion 335 of the knob 330 is formed with a through-hole 335A for draining water leaking from a gap between the operation portion 336 and the panel upper surface portion 121 to the outside of the knob 330.

### Modified Example 3 of the Knob 130

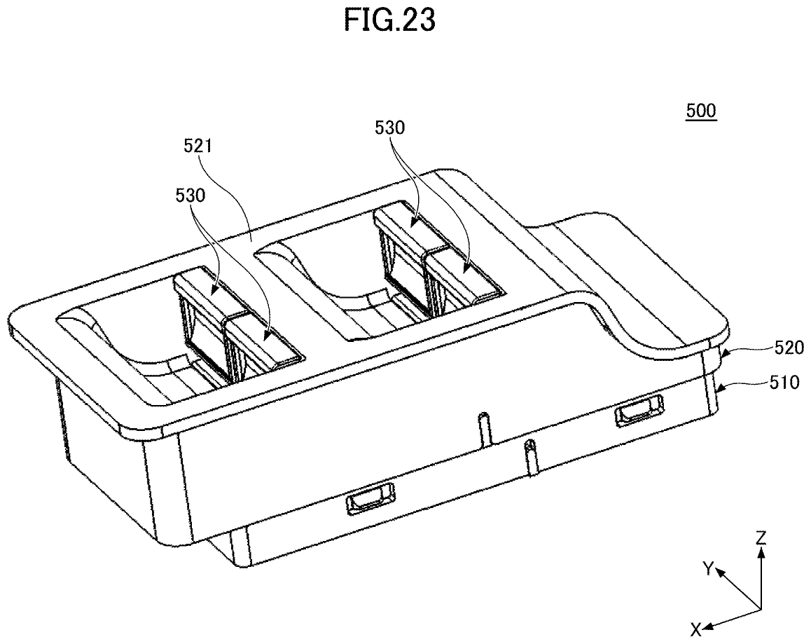

FIG. 22 is a sectional view for explaining the through-hole of modified example 3 of the knob 130 according to one embodiment. The knob 430 illustrated in FIG. 22 is modified example 3 of the knob 130 according to one embodiment. The knob 430 has a pair of side wall portions 434E provided perpendicular to the Y-axis direction. As illustrated in FIG. 22, the knob 430 has a through-hole 434I penetrating the side wall portion 434E closer to the operation portion 436 than the end portion 434D of the side wall portion 434E. Thus, the knob 430 can discharge the water entering between the wall portion 435 and the first inclined portion 434A from the through-hole 434I. That is, in the side wall portion 434E perpendicular to the virtual swing center axis direction (Y-axis direction) of the knob 430, a through-hole 434I for draining the water leaking from the gap between the operation portion 436 and the panel upper surface portion 121 to the outside of the knob 430 is formed.

### Modified Example of the Input Apparatus 100

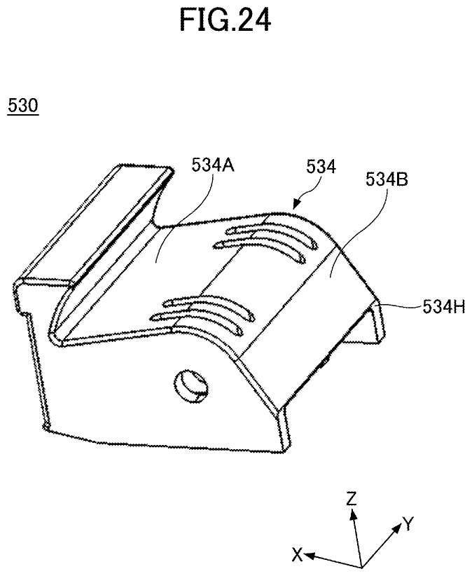

FIG. 23 is an external perspective view of an input apparatus 500 including modified example 4 of the knob 130 according to an embodiment. FIG. 24 is a perspective view of modified example 4 of the knob 130 according to an embodiment. The input apparatus 500 includes a knob 530 (an example of a “knob”) having no light guide hole. Therefore, the input apparatus 500 does not have an illumination display function. As illustrated in FIG. 24, the knob 530 of the input apparatus 500 has no through-hole for light guidance formed in the base portion 534, and the base portion 534 is structurally stronger than the base portion of the other embodiment because the first inclined portion 534A and the second inclined portion 534B are continuous. Therefore, because the peripheral portion of the second inclined portion 534B has a margin of structural strength, even if the rear end portion 534H of the base portion 534 is has its dimension reduced on the front side, the peripheral portion of the second inclined portion 534B is less likely to be broken. That is, because the size of the base portion 534 in the front-rear direction (X-axis direction) can be reduced, the size of the input apparatus 500 can be reduced. Although the size of the outer contour of the panel upper surface portion 121 of the input apparatus 100 when viewed in plan view is the same as the size of the outer contour of the entire panel member 120, the size of the panel upper surface portion 521 (an example of the “panel upper surface portion”) of the input apparatus 500 when viewed in plan view is smaller than the size of the outer contour of the panel member 520. Other configurations of the input apparatus 500 are the same as those of the input apparatus 100.

According to the input apparatus according to an embodiment, the possibility of erroneous operation can be reduced and the safety of the occupant of the vehicle can be enhanced.

Although one embodiment of the present invention has been described in detail above, the present invention is not limited to these embodiments, and various modifications and changes are possible within the scope of the present invention as set forth in the appended claims.

What is claimed is:

1. An input apparatus comprising:
a housing;
a panel member that covers the housing;
a knob operated by an operator; and
a contact configured to generate a signal when the knob is pressed by a predetermined pressing amount or more, wherein
the panel member includes:
a panel upper surface portion having a planar shape; and
an opening portion formed in the panel upper surface portion and exposing at least a part of the knob,
the knob includes:
a base portion having a virtual swing center axis supported by the housing and covered by the panel upper surface portion and swinging around the virtual swing center axis;
a front wall portion provided at the base portion and extending from below the opening portion toward the opening portion; and
an operation portion provided at an end portion of the front wall portion and exposed from the opening portion to receive an operation force from the operator, and
the operation portion includes a pressing operation surface portion pressed by the operator, wherein
when viewed from a direction of the virtual swing center axis, a vertical relative position of the pressing operation surface portion with respect to the panel upper surface portion is located above the panel upper surface portion in a neutral state released from the operation force, and when the pressing operation surface portion pressed by the operation force transitions from the neutral state to be on a same plane as the panel upper surface portion, an amount of pressing of the contact by the knob becomes less than the predetermined pressing amount and the contact is provided at a position where the signal is not generated, and
when the pressing operation surface portion further pressed by the operation force transitions below the panel upper surface portion, the amount of pressing of the contact by the knob becomes greater than or equal to the predetermined pressing amount and the contact is provided at a position where the signal is generated.

2. The input apparatus according to claim 1, wherein
the base portion includes:
a first inclined portion which, when viewed from the direction of the virtual swing center axis, is provided on a side closer to the opening portion and on a side of the panel upper surface portion with respect to the virtual swing center axis, the first inclined portion being inclined with respect to the panel upper surface portion, in such a direction that a distance between the first inclined portion and the panel upper surface portion increases as a distance between the first inclined portion and the opening portion decreases; and
a second inclined portion which, when viewed from the direction of the virtual swing center axis, is provided on a side opposite to the first inclined portion in a front-rear direction with respect to the virtual swing center axis, the second inclined portion being inclined with respect to the panel upper surface portion, in such a direction that a distance between the second inclined portion and the panel upper surface portion increases as a distance between the second inclined portion and the opening portion increases.

3. The input apparatus according to claim 1, wherein when viewed from the direction of the virtual swing center axis, an internal angle formed by an intersection of the operation portion and the front wall portion on a rear side of the pressing operation surface portion of the operation portion and on a side distant from the virtual swing center axis, is an acute angle.

4. The input apparatus according to claim 1, wherein in a front-rear direction, when a value of a width of the operation portion is 1, a value of a dimension obtained by subtracting a dimension of the width of the operation portion from an overall dimension of the knob in the front-rear direction is from 1.8 to 2.2.

5. The input apparatus according to claim 4, wherein in the front-rear direction, when the width of the operation portion is 6 mm, a dimension obtained by subtracting the dimension of the width of the operation portion from the overall dimension of the knob in the front-rear direction is 12 mm.

6. The input apparatus according to claim 1, wherein in a front-rear direction, when a value of a width of the operation portion is 1, a value of a dimension obtained by subtracting a dimension of the width of the operation portion from an overall dimension of the opening portion in the front-rear direction is from 1.8 to 3.7.

7. The input apparatus according to claim 6, wherein in the front-rear direction, when the width of the operation portion is 6 mm, a dimension obtained by subtracting the dimension of the width of the operation portion from the overall dimension of the opening portion in the front-rear direction is 22 mm.

8. The input apparatus according to claim 2, wherein
the knob includes:
a pulling operation surface portion formed by forming a recessed portion at an inner angle defined by intersecting the operation portion and the front wall portion when viewed from the direction of the virtual swing center axis, on a rear side of the pressing operation surface portion of the operation portion and on a side distant from the virtual swing center axis; and
a first rib that is provided in the recessed portion, the first rib connecting the front wall portion and the pulling operating surface portion and extending in a plane direction perpendicular to the direction of the virtual swing center axis.

9. The input apparatus according to claim 8, wherein a pair of the first ribs are provided on the front wall portion and spaced apart in the direction of the virtual swing center axis.

10. The input apparatus according to claim 2, wherein the knob includes:
a second rib provided on the front wall portion, with an end face of the second rib forming the first inclined portion of the base portion, the second rib extending in a plane direction perpendicular to the direction of the virtual swing center axis.

11. The input apparatus according to claim 8, wherein the panel member includes:
a mechanical stopper extending toward the first inclined portion of the knob and contacting the first inclined portion of the knob when the knob is swung by a predetermined amount by a pulling operation with respect to the pulling operation surface portion.

12. The input apparatus according to claim 2, wherein a through-hole is formed in the front wall portion of the knob for draining water to outside the knob, the water leaking from a gap between the operation portion and the opening portion of the panel upper surface portion.

13. The input apparatus according to claim 2, wherein the knob has a pair of side wall portions perpendicular to the direction of the virtual swing center axis, wherein a through-hole is formed in the side wall portion for draining water to outside the knob, the water leaking from a gap between the operation portion and the opening portion of the panel upper surface.

14. The input apparatus according to claim 1, wherein
the panel member has a first facing surface portion provided on an inner wall constituting the opening portion to face the operation portion of the knob, the first facing surface portion being formed in a direction obliquely intersecting with the panel upper surface portion, and
the operation portion of the knob has a second facing surface portion parallel to the first facing surface portion with a small gap therebetween, in the neutral state.

15. The input apparatus according to claim 1, wherein the pressing operation surface portion has a planar shape and is provided parallel to the panel upper surface portion in the neutral state.

16. An input apparatus comprising:
a housing;
a panel member that covers the housing;
a knob operated by an operator; and
a contact configured to generate a signal when the knob is pressed by a predetermined pressing amount or more, wherein
the panel member includes:
a panel upper surface portion having a planar shape; and
an opening portion formed in the panel upper surface portion and exposing at least a part of the knob,
the knob includes:
a base portion having a virtual swing center axis supported by the housing and covered by the panel upper surface portion and swinging around the virtual swing center axis;
a front wall portion provided at the base portion and extending from a side of the opening portion of the base portion toward the opening portion; and
an operation portion provided at the front wall portion and exposed from the opening portion to receive an operation force from the operator, and
a side of the virtual swing center axis of the operation portion has a same curvature as a side surface of a cylinder about the virtual swing center axis and has a curved shape overlapping the side surface of the cylinder.

17. An input apparatus comprising:
a housing;
a panel member that covers the housing; and
a knob operated by an operator, wherein
the panel member includes:
a panel upper surface portion having a planar shape; and
an opening portion formed in the panel upper surface portion and exposing at least a part of the knob,
the knob includes:
a base portion having a virtual swing center axis supported by the housing and covered by the panel upper surface portion and swinging around the virtual swing center axis, and
the base portion includes:
a first inclined portion inclined with respect to the panel upper surface portion, in such a direction that a distance between the first inclined portion and the panel upper surface portion increases as a distance between the first inclined portion and the opening portion decreases; and
a second inclined portion inclined with respect to the panel upper surface portion, in such a direction that a distance between the second inclined portion and the panel upper surface portion increases as a distance between the second inclined portion and the opening portion increases.

18. The input apparatus according to claim 17, further comprising:
a contact configured to generate a signal when the knob is pressed by a predetermined pressing amount or more, wherein
the knob includes:
a front wall portion provided at the base portion and extending from a side of the opening portion of the base portion toward the opening portion; and
an operation portion provided at the front wall portion and exposed from the opening portion to receive an operation force from the operator.
